(19) United States
(12) Patent Application Publication
(10) Pub. No.: US 2011/0265890 A1
(43) Pub. Date: Nov. 3, 2011

(54) APPARATUS FOR CONTROLLING VOLUME OF WATER TO A SHOWER HEAD

(76) Inventor: Patrick Killian, San Rafael, CA (US)

(21) Appl. No.: 12/769,631

(22) Filed: Apr. 28, 2010

(51) Int. Cl. F16K 17/36

(52) U.S. Cl. 137/468

(57) ABSTRACT

An apparatus includes a volume control valve for controlling a flow of water to a shower head. The volume control valve is configured for joining between a shower neck and the shower head. A guide tube includes a cable joined to the volume control valve for operating the volume control valve by motion of the cable. The guide tube is configured for extending vertically downward from the volume control valve along a shower wall. A control mechanism including a lever and joined to a distal end of the guide tube enables an adjustment of the flow of water. The control mechanism is configured for joining to the shower wall where a controlled motion of the lever is translated by the cable as a linear motion to the volume control valve thereby operating the control valve.

### CROSS-REFERENCE TO RELATED APPLICATIONS

The present Utility patent application claims priority benefit of the U.S. provisional application for patent Ser. No. 61/212,200 filed on Apr. 29, 2009, and entitle “Shower water volume control device with mechanism for water volume adjustment and integrated water volume and temperature gauge”, under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to shower fixtures. More particularly, the invention relates to a shower water volume control device.

### BACKGROUND OF THE INVENTION

Most shower installations do not provide the ability to control the water volume once the water temperature has been set or during the taking of a shower. In other words, there is no ability to turn down the flow of water during the shower. In most applications, a user must turn the water off if he wishes to soap up or shave without the flow of water. Then, the user must readjust the temperature as he turns the shower valve back on. Even though it is becoming a common practice to replace high flow showerheads with low flow showerheads, the taking of a shower still uses a significant amount of water. It is therefore an objective of the present invention to provide means for controlling the volume of water coming from a showerhead during the taking of a shower.

It is possible to install volume control valves when building or remodeling a bathroom. However, very few installations include this option. Also, there are some showerheads that have an integrated shut off valve. However, these showerheads typically require the user to reach high above his head and to push the valve closed. These valves are not easy to operate and do not easily enable the user to control of the water volume. There are also other types of devices that do give users some ability to moderate the flow of water during the taking of a shower One is a simple inline valve that operates by rotating a lever attached directly to the valve. This valve is primarily intended to turn the water flow off and on and not to moderate the flow of the water. Another is a shower head with a temperature sensing mechanism that shuts the water down when it reaches the appropriate temperature. This was designed so that when the shower is turned on you are not wasting water while waiting for the water to get warm enough. It does not moderate the flow of water during the shower. However, these devices also require the user to reach above his head in order to perform this operation. Therefore, users that are unable to reach up high such as, but not limited to children, short individuals, older individuals, or disabled individuals are unable to make use of these devices.

There have been some retrofit solutions for controlling the volume of water through the showerhead. There are only two or three such devices that are actively sold in the marketplace. The first is a simple shut off valve that is placed between the shower neck and the showerhead. This device operates by sliding a rod from one side of the showerhead to the other. This device enables a user to turn off the water or even moderate the flow, although moderating the flow with this device is not easy. The second device is intended to give more control of water volume. Once again, this device is placed between the shower neck and the showerhead. This device has a lever that enables a user to adjust the volume by rotating the lever forward or back. The third device is similar to the second device except that it has a knob which turns the valve in a clockwise or counterclockwise direction to control the volume of water instead of a lever. The rotation of this valve is small and not as easy to adjust as a lever.

These solutions do not solve the ease of use issue as all of the above devices require the user to reach high above his head in order to reach the valve to make the adjustment. Also, it is not easy to adjust the water volume in small increments while using these devices near the showerhead. Furthermore, none of the devices provide means for giving the user instantaneous water usage feedback on temperature, gallons per minute and total gallons used to enable the user to make accommodations to adjust water usage accordingly.

In view of the foregoing, there is a need for improved techniques for providing a shower water volume control device that enables a user to easily control the volume of water and receive feedback on volume usage and water temperature during the taking of a shower.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate an exemplary shower water volume control device with a detached control mechanism for water volume adjustment and an integrated water volume and temperature gauge, in accordance with an embodiment of the present invention. FIG. 1A is a diagrammatic side view, and FIG. 1B is a diagrammatic front view;

FIG. 2 is a diagrammatic side view of an exemplary shower water volume control device with a flexible shaft, in accordance with an embodiment of the present invention;

FIG. 3 is a diagrammatic side view of an exemplary shower water volume control device with a flexible shaft, in accordance with an embodiment of the present invention;

FIGS. 4A and 4B illustrate an exemplary shower water volume control device with a vertical control mechanism and a semi rigid cable by which to control a volume control valve, in accordance with an embodiment of the present invention. FIG. 4A is a diagrammatic side view, and FIG. 4B is a diagrammatic front view;

FIGS. 5A and 5B illustrate an exemplary rotating disc cable control mechanism, in accordance with an embodiment of the present invention. FIG. 5A is a diagrammatic front view of the rotating disc cable control mechanism, and FIG. 5B is a cutaway drawing which shows the inner workings of the rotating disc control mechanism;

FIG. 6 is a diagrammatic front view of an exemplary dial control mechanism to operate a volume control valve for a shower water volume control device, in accordance with an embodiment of the present invention;

FIG. 7 is a diagrammatic side view of an exemplary showerhead and volume control valve integrated into one unit, in accordance with an embodiment of the present invention;

FIG. 8 illustrates an exemplary water volume and temperature gauge, which may be integrated to into a shower water volume control device, in accordance with an embodiment of the present invention; and

FIG. 9 is a front view of an exemplary vertical control mechanism of a shower water volume control device with an integrated volume and temperature gauge, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, an apparatus for controlling volume of water to a shower head is presented. In one embodiment an apparatus includes means for controlling a flow of water to a shower head, means for operating the controlling means and means for enabling an adjustment of the flow of water thereby operating the controlling means. Another embodiment further includes means for monitoring a volume of the flow of water, means for monitoring a temperature of the flow of water and means for displaying the volume and the temperature.

In another embodiment an apparatus includes a volume control valve for controlling a flow of water to a shower head. The volume control valve is configured for joining to a shower neck. A shaft is joined to the volume control valve for operating the volume control valve. The shaft is configured for extending vertically downward from the volume control valve along a shower wall. A control mechanism is joined to a distal end of the shaft for enabling an adjustment of the flow of water. The control mechanism is configured for joining to the shower wall where a controlled motion of the control mechanism is translated by the shaft to the volume control valve thereby operating the control valve. In another embodiment the control mechanism further includes a lever for imparting the controlled motion. In yet another embodiment the lever operates vertically and the controlled motion is linear. Still another embodiment further includes a water volume sensor for monitoring a volume of the flow of water, a temperature sensor for monitoring a temperature of the flow of water, and a gauge assembly in communication with the water volume sensor and the temperature sensor for displaying the volume and the temperature. In another embodiment at least part of the shaft is flexible. Yet another embodiment further includes at least one support for supporting the shaft. In still another embodiment the shaft is hollow and includes a cable for translating the controlled motion. In another embodiment the volume control valve is joined between the shower neck and the shower head. In yet another embodiment the volume control valve further includes a shower head. In still another embodiment the gauge assembly includes electronic displays. In another embodiment the gauge assembly further displays time and time related data. In yet another embodiment the gauge assembly is programmable. In still another embodiment the gauge assembly is joined to the control mechanism. In another embodiment the gauge assembly is configurable for imparting the controlled motion.

In another embodiment an apparatus includes a volume control valve for controlling a flow of water to a shower head. The volume control valve is configured for joining between a shower neck and the shower head. A guide tube includes a cable joined to the volume control valve for operating the volume control valve by motion of the cable. The guide tube is configured for extending vertically downward from the volume control valve along a shower wall. A control mechanism including a lever and joined to a distal end of the guide tube enables an adjustment of the flow of water. The control mechanism is configured for joining to the shower wall where a controlled motion of the lever is translated by the cable as a linear motion to the volume control valve thereby operating the control valve. Another embodiment further includes a water volume sensor for monitoring a volume of the flow of water, a temperature sensor for monitoring a temperature of the flow of water, and a programmable gauge assembly in communication with the water volume sensor and the temperature sensor for displaying the volume, the temperature, time and time related data. In yet another embodiment the gauge assembly is joined to the control mechanism. In still another embodiment the gauge assembly is configurable for imparting the controlled motion.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide easy and accessible means for modifying the flow of water through a showerhead while showering and for providing feedback to a user concerning water volume, temperature, and time so that the user may modify their shower usage. An object of preferred embodiments of the present invention is to provide means for controlling the volume of water passing through the showerhead while showering. Another object of preferred embodiments of the present invention is to control the volume of water passing through the showerhead without the need to reach up to the height of the showerhead. Another object of preferred embodiments of the present invention is to provide means for controlling the volume of water near the middle of the shower wall and approximately waist high for normal adults. Another object of preferred embodiments of the present invention is to provide means for saving water during showering. Another object of preferred embodiments of the present invention is to provide means for reducing hot water heating costs while showering. Another object of preferred embodiments of the present invention is to provide means for controlling the volume of water while soaping the body, shaving in the shower, and other related activities where full water volume is undesirable. Another object of preferred embodiments of the present invention is to provide feedback on water usage via a digital and/or mechanical water volume and temperature gauge. Another object of preferred embodiments of the present invention is to provide ease of use for controlling shower water volume for short people or children. Another object of preferred embodiments of the present invention is to easily moderate, over a full range of control, the water volume exiting a showerhead. Another object of preferred embodiments of the present invention is to enable the device to moderate the flow of water based on pre-programmed settings. Another object of preferred embodiments of the present invention is to provide a timer or alarm integrated into a gauge that signals the user when a desired volume of water has been used. Another object of preferred embodiments of the present invention is to provide pre-programmed automatic control of the water volume.

Preferred embodiments of the present invention provide users with easily accessible means for controlling the volume of water from fully open to a full range of partial water flow levels to completely off without the need to readjust the water temperature. Preferred embodiments comprise a control mechanism that is much more accessible than conventional devices during the taking of a shower, even for children, older individuals or other users that may have trouble reaching the showerhead. Preferred embodiments enable a user to fine-tune the water volume settings easily and quickly. Preferred embodiments also provide means of providing feedback to the user of water volume, gallons used, temperature, time and other related information. Preferred embodiments may be integrated into a new shower installation or may be retrofit into an existing shower installation. The ease of access, the ease of use, the ability to fine-tune the shower volume settings, and the ability to receive immediate feedback on water volume and temperature are advantages of preferred embodiments of the present invention over the prior art.

Preferred embodiments of the present invention are designed with a digital and/or mechanical water volume and temperature gauge that indicate information such as, but not limited to, the gallons of water used per minute, the total gallons used per shower and the water temperature. The gauge preferably has the ability to be pre-programmed for each individual user such that the unit supplies information on water usage and can notify the user when a programmed event such as, but not limited to, a length of time or a number of gallons has been exceeded. The gauge may also comprise sound alarms to notify the user of such events and other information necessary to help the user moderate his shower usage. Alternate embodiments may include automatic adjusting of the water volume based on pre-programmed settings and a mechanical linkage between the gauge and the control mechanism.

Some preferred embodiments of the present invention comprise a lever or knob to control a volume control valve in line with the shower neck rather than between the shower neck and showerhead, as in the prior art. In typical use of preferred embodiments, instead of having to turn the water off, which most people showering do not do, or reach up to actuate a valve connected to the showerhead, a user has easy and accurate control of the water flow positioned at a height that is convenient for all users. The user may wish to turn the volume of water up or down many times during the taking of a shower depending on whether they are washing their hair, soaping up, washing off, etc. In most instances it is found that full volume is never required, and therefore water and heat are saved during the entire shower. Because of the ease of use of preferred embodiments of the present invention, it is expected that users can save significantly not only on the amount of water being used during the shower, but also on the energy necessary to heat this water. Considering the limited water availability in many regions, preferred embodiments are intended to help reduce shower water usage up to 50%, or even more, as well as reduce water heating costs by 50% or more.

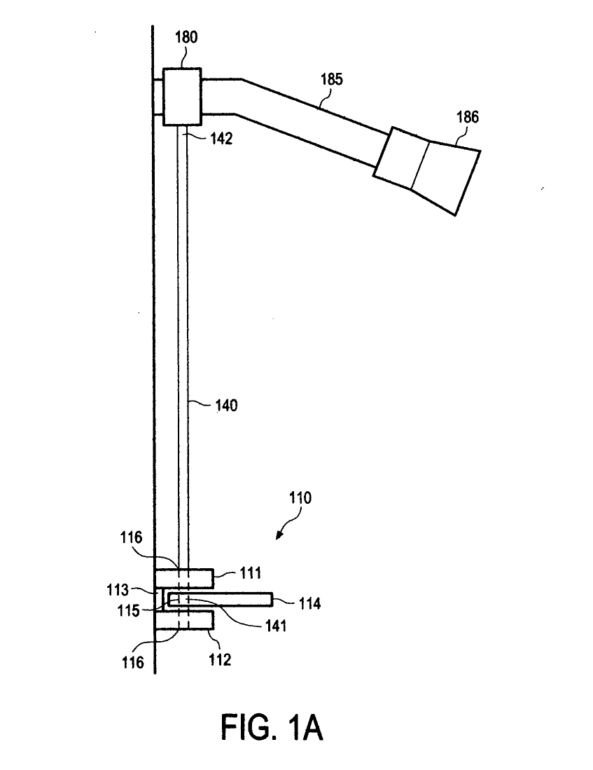

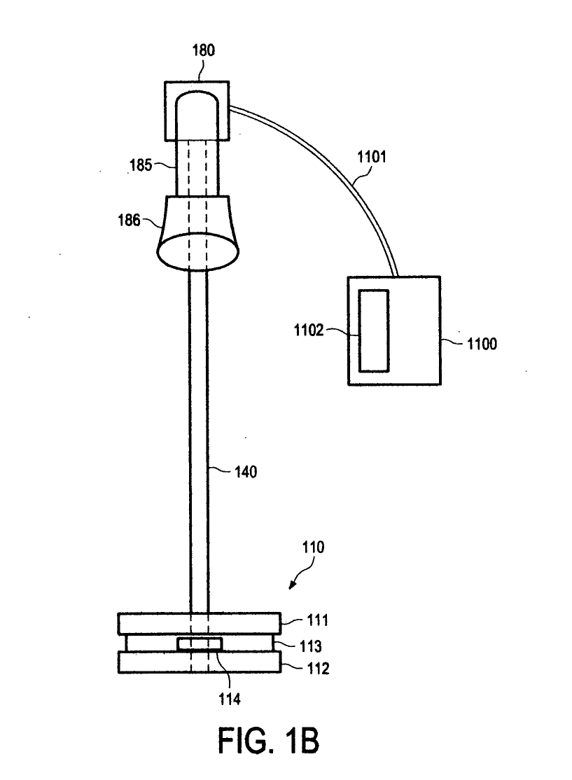

FIGS. 1A and 1B illustrate an exemplary shower water volume control device with a detached control mechanism 110 for water volume adjustment and an integrated water volume and temperature gauge 1100, in accordance with an embodiment of the present invention. FIG. 1A is a diagrammatic side view, and FIG. 1B is a diagrammatic front view. In the present embodiment, the volume control device comprises a straight shaft 140 that is attached to a horizontal control mechanism 110 on the wall preferably placed slightly above the main shower control. However, the control mechanisms in alternate embodiments may be placed in various different locations. For example, without limitation, in shower installations that are shower and tub combinations, the control mechanism may be placed much higher than the main shower control, and in some embodiments the control mechanisms may be placed at eye level. In the present embodiment, straight shaft 140 connects directly to a volume control valve 180 placed before a shower neck 185 which holds a showerhead 186. Straight shaft 140 connects to volume control valve 180 with connection means 142. Those skilled in the art, in light of the present teachings, will readily recognize that a multiplicity of suitable connection means may be used to connect straight shaft 140 to volume control valve 180 such as, but not limited to, connection pins, set screws, welding, adhesives, etc. Referring to FIG. 1B volume gauge 1100 and a connecting cable 1101 are shown connected to volume control valve 180. Volume gauge 1100 may be a digital or mechanical gauge and comprises a display 1102 to display information such as, but not limited to, gallons used per minute, total gallons used, water temperature, time, etc.

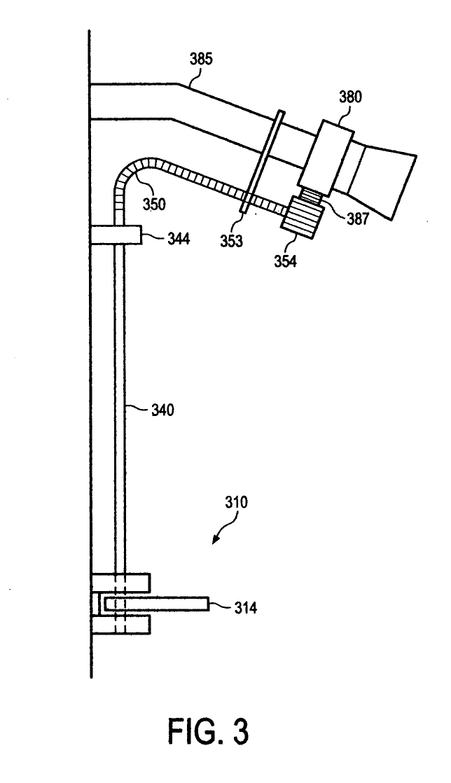

Volume control valve 180 is the means by which the water flow is modified. When volume control valve 180 is turned by straight shaft 140, the water flow can be moderated from fully open to fully closed and everything in between. Volume control valve 180 is typically, but not necessarily, a ball valve adapted to mate with straight shaft 140 such that volume control valve 180 can be indirectly turned by horizontal a lever 114. Volume control valve 180, as in most ball valves, has a stem extending from it that rotates valve 180 to either restrict or open valve 180 thus regulating the water volume. In an alternate embodiment, as shown by way of example in FIG. 3, the volume control valve may have an external gear that rotates the internal valve thus regulating the water volume. Those skilled in the art, in light of the present teachings, will readily recognize that a multiplicity of suitable valves may be used in place of a ball valve as the volume control valve such as, but not limited to, butterfly valves, globe valves, needle valves, gate valves, etc.

In the present embodiment horizontal control mechanism 110 comprises horizontal lever 114; however, alternate embodiments may implement various different types of control means such as, but not limited to, vertical levers, round knobs, disc-shaped dials, etc. In the present embodiment, straight shaft 140 is vertically connected to horizontal lever 114 by sliding into a hole 115 in horizontal lever 114. Connection means 141 hold horizontal lever 114 in place on straight shaft 140 so that horizontal lever 114 does not slide up and down on or rotate about straight shaft 140. Those skilled in the art, in light of the present teachings, will readily recognize that a multiplicity of suitable connection means may be used to secure horizontal lever 114 to straight shaft 140 such as, but not limited to, connection pins, set screws, welding, adhesives, threaded fasteners, etc. Horizontal lever 114 may be any kind of elongated device of any shape that is mounted at a right angle to straight shaft 140. Horizontal lever 114 extends out from straight shaft 140 to a sufficient length so that horizontal lever 114 may be easily gripped. The base of horizontal lever 114 comprises two horizontal aligned plates, a top plate 111 and a bottom plate 112, separated by a vertical back plate 113. In the present embodiment top plate 111 and bottom plate 112 are generally rectangular in shape; however, alternate embodiments may be implemented with plates of various different shapes such as, but not limited to, round discs, square plates, semicircular plates, etc. In the present embodiment, back plate 113 is attached at the rear of both top plate 111 and bottom plate 112 so that there is an open space between top plate 111 and bottom plate 112. Horizontal lever 114 is placed snugly but not tightly between top plate 111 and bottom plate 112. Straight shaft 140 penetrates the lever base through both top plate 111 and bottom plate 112. Horizontal lever 114 is attached directly to straight shaft 140 in the space made by vertical back plate 113 in which horizontal lever 114 can swivel. Straight shaft 140 penetrates holes 116 in top plate 111 and bottom plate 112 with sufficient play to move freely in holes 116. In alternate embodiments the horizontal control mechanisms may be constructed differently. For example, without limitation, alternate embodiments may comprise only a top plate or a bottom plate rather than both. Other alternate embodiments may not comprise plates and instead the straight shaft may be secured to the wall using various different means such as, but not limited to, brackets, clamps, wall anchors, etc.

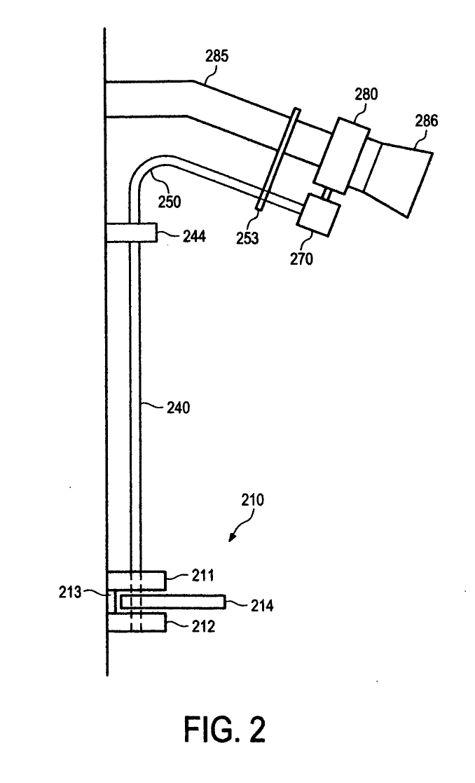

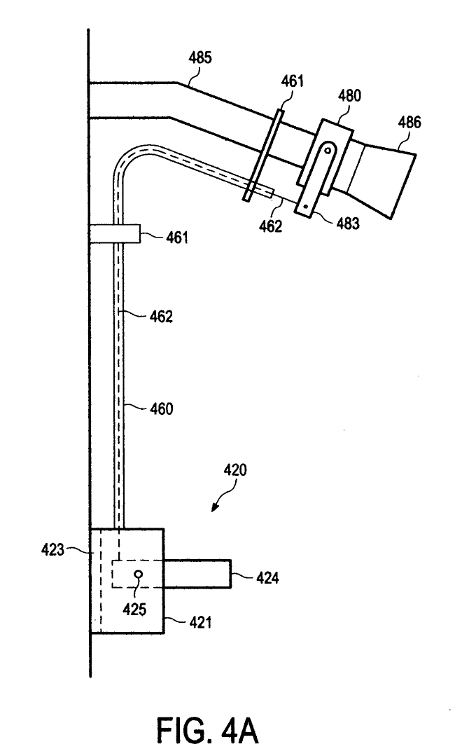

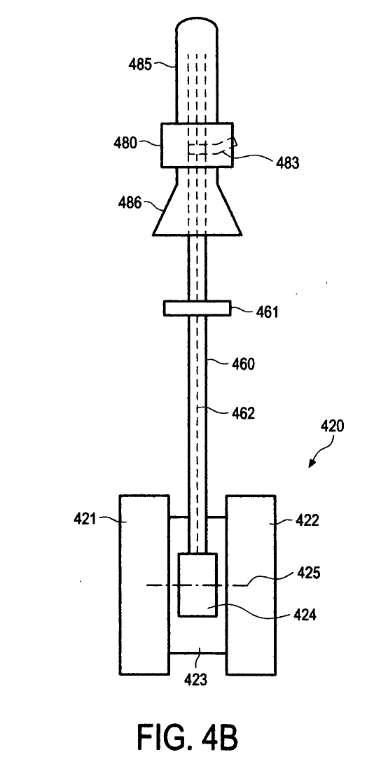

In the present embodiment, straight shaft 140 runs from horizontal control mechanism 110 directly to volume control valve 180. However, in an alternate embodiment, shown by way of example in FIG. 2, a straight shaft runs from the horizontal control mechanism upward to where it connects to a flexible shaft, which continues on to connect with a right angle gearbox that connects to the volume control valve. Those skilled in the art, in light of the present teaching, will readily recognize that the control mechanism may be connected to the volume control valve using various different means in other alternate embodiments. For example without limitation, the control mechanism may connect to the volume control valve using a cable as shown by way of example in FIGS. 4A and 4B or these elements may be connected by a chain, multiple rigid shafts, a bent or curved shaft, etc. In the present embodiment, straight shaft 140 connects to horizontal lever 114 at horizontal control mechanism 110 such that the turning of horizontal lever 114 transfers a clockwise or counter clockwise movement upwards to volume control valve 180. The length of straight shaft 140 may vary in specific implementations of the present embodiment, and in alternate embodiments the length of the straight shaft may be adjustable. In typical use of the present embodiment, a user turns horizontal lever 114, which turns straight shaft 140, which adjusts volume control valve 180 and moderates the water flow.

FIG. 2 is a diagrammatic side view of an exemplary shower water volume control device with a flexible shaft 250, in accordance with an embodiment of the present invention. In the present embodiment, a volume control valve 280 is placed past a shower neck 285 near a showerhead 286. In this embodiment a straight shaft 240 that rises from a control mechanism 210 eventually connects with flexible shaft 250. Flexible shaft 250 follows under the curve of shower neck 285 and eventually connects with a right angle gearbox 270. Right angle gearbox 270 is attached to volume control valve 280. As straight shaft 240 is turned, it likewise turns flexible shaft 250 and right angle gearbox 270. Right angle gearbox 270 adjusts volume control valve 280, and the water flow is moderated.

In the present embodiment, horizontal control mechanism 210 is similar to horizontal control mechanism 110 shown by way of example in FIGS. 1A and 1B. Horizontal control mechanism 210 comprises a horizontal lever 214, a top plate 211, a bottom plate 212, and a back plate 213. In alternate embodiments, horizontal control mechanisms of various different configurations or different types of control mechanisms may be used in place of horizontal control mechanism 210 such as, but not limited to, vertical control mechanisms, knobs, discs, etc. In the present embodiment, straight shaft 240 is vertically connected to horizontal lever 214. As straight shaft 240 nears shower neck 285 it is connected to flexible shaft 250. Shaft stabilizer anchors 244 and 253 hold straight shaft 240 and flexible shaft 250 in place, respectively. Alternate embodiments may be implemented without one or both of the shaft stabilizer anchors, and other alternate embodiments may comprise more shaft stabilizer anchors.

In the present embodiment, flexible shaft 250 is utilized as an alternative variation to a straight, rigid shaft. If volume control valve 280 is placed at the end of shower neck 285, one option is to implement flexible shaft 250 in order to extend straight shaft 240 to the end of shower neck 285 Flexible shaft 250 is bent in an arch and follows the bottom side of the curve of shower neck 285 from straight shaft 240 to right angle gearbox 270. In alternate embodiments the configuration of the straight shaft and the flexible shaft may vary. For example, without limitation the straight shaft may end lower on the shower wall so the flexible shaft can extend straight toward the volume control valve without curving. Another alternate embodiment may be implemented that does not include a straight shaft; instead, the flexible shaft extends from the control mechanism to the volume control valve. In the present embodiment, flexible shaft 250 allows for the turning motion of horizontal lever 214 to be transferred through straight shaft 240 then through flexible shaft 250 then through right angle gear box 270 and finally to volume control valve 280. Right angle gear box 270 serves to transfer the motion of straight shaft 240 and flexible shaft 250 to volume control valve 280. Since flexible shaft 250 sits approximately parallel to shower neck 285 and volume control valve 280 in the present embodiment, right angle gearbox 270 transfers the force of the turning shafts to turn or adjust volume control valve 280. Alternate embodiments may be implemented with means other than a right angle gear box to connect the flexible shaft to the volume control valve such as, but not limited to, gears on flexible shaft and control valve, shown by way of example in FIG. 3. In most cases in may be necessary to use a right angle gear box or some similar type of gear mechanism when transfering the motion of the rotating flexible shaft to a control valve that uses a ball valve mechanism that rotates clockwise or counter clockwise. Another alternative would be the flexible shaft with a gear at its end. A choke valve opened and closed by a rotating gear meshes with the gear at the end of the flexible shaft. As the flexible shaft is rotated the gear at its end turns the gear attached to the chock valve and the water flow is moderated.

FIG. 3 is a diagrammatic side view of an exemplary shower water volume control device with a flexible shaft 350, in accordance with an embodiment of the present invention. The present embodiment may be implemented without a right angle gearbox since flexible shaft 350 is directly linked to a volume control valve 380 with a rotating volume control gear 387. A flexible shaft gear 354 located on the end of flexible shaft 350 meshes with volume control gear 387 built into volume control valve 380. In the present embodiment a horizontal control mechanism 310 comprising a horizontal lever 314 enables a user to operate the volume control device. However, in alternate embodiments, various different types of control mechanisms may be used to enable the user to operate the volume control device such as, but not limited to, knobs or dials. In the present embodiment, horizontal lever 314 is connected to a straight shaft 340, which, as it rises closer to a shower neck 385 is connected to flexible shaft 350. The straight shaft and flexible shaft in alternate embodiments may be shaped and positioned differently. For example, without limitation, the straight shaft may extend above the shower neck so the flexible shaft is located above the shower neck. In this embodiment, the volume control gear is preferably located on the top of the volume control valve for easy connection to the flexible shaft gear. Another alternate embodiment may be implemented that does not include a straight shaft; instead, the flexible shaft extends from the control mechanism to the volume control valve. In the present embodiment, flexible shaft gear 354 meshes with volume control gear 387 on the bottom side of volume control valve 380. When straight shaft 340 and flexible shaft 350 are rotated by control mechanism 310, flexible shaft gear 354 moves volume control gear 387. This adjusts volume control valve 380 thus moderating the water volume. Shaft stabilizer anchors 344 and 353 are also shown holding the straight shaft 340 and flexible shaft 350 in place; however, these anchors may not be included or more may be used in alternate embodiments.

FIGS. 4A and 4B illustrate an exemplary shower water volume control device with a vertical control mechanism 420 and a semi rigid cable 462 by which to control a volume control valve 480, in accordance with an embodiment of the present invention. FIG. 4A is a diagrammatic side view, and FIG. 4B is a diagrammatic front view. This is a preferred embodiment of the present invention because of its ease of installation and ease of use. In the present embodiment, a shaft is a guide tube 460 rising out of control mechanism 420 up the wall and attaching under the curve of a shower neck 485. Guide tube 460 is preferably metal or plastic; however alternate materials such as, but not limited to, rubber may be used. Volume control valve 480 is placed past shower neck 485 near a showerhead 486 in this embodiment. In guide tube 460 is semi rigid cable 462 that is connected to control mechanism 420 and then to a linkage 483 that connects to volume control valve 480.

Stationary guide tube 460 extends vertically from vertical control mechanism 420. Guide tube 460 bends and runs parallel to shower neck 485 and ends near showerhead 486. In alternate embodiments, the guide tube may be bent in various different configurations in order to reach the volume control vale. For example, without limitation, the guide tube may be bent at a right angle to the wall or may angle out from the wall below the showerhead to reach the volume control valve rather than following the curve of the shower neck. In the present embodiment, semi rigid cable 462 is able to slide inside guide tube 460. The raising and lowering of a vertical lever 424 of vertical control mechanism 420 raises and lowers semi rigid cable 462 within guide tube 460. Guide tube 460 is held rigid and unmovable by its connection to vertical control mechanism 420 and by tube supports 461 on the wall and attached to shower neck 485. Alternate embodiments may be implemented without one or both of the tube supports, and other alternate embodiments may comprise more tube supports. In the present embodiment, guide tube 460 ends slightly before volume control valve 480, allowing for semi rigid cable 462 in guide tube 460 to connect with linkage 483 from volume control valve 480. As semi rigid cable 462 is pushed upward or downward in guide tube 460 by the action of vertical lever 424, cable linkage 483, which is attached to volume control valve 480, opens or closes volume control valve 480 to various degrees. In the present embodiment, guide tube 460 preferably comprises a small tube within a larger tube. This enables the larger tube to slide up or down over the small tube in order to adjust the length of guide tube 460 as needed for various different shower installations. In alternate embodiments, the guide tube may be made adjustable by using a flexible guide tube. In other alternate embodiments the guide tube may not be adjustable. In these non-adjustable embodiments, the guide tube is a single rigid tube.

In the present embodiment, guide tube 460 is attached to vertical control mechanism 420; however, in alternate embodiments various different types of control mechanisms may be used such as, but not limited to, a knob with gear, a rotating base for pushing and pulling the cable, or a horizontal lever with a cam that pushes and pulls the cable through the tube. In the present embodiment, vertical control mechanism 420 comprises two parallel vertically aligned plates 421 and 422 separated by a vertical back plate 423. Back plate 423 is attached at the rear of both parallel plates 421 and 422 so that there is an open space between parallel plates 421 and 422. Vertical lever 424 is placed snugly but not tightly between parallel plates 421 and 422 and a pin 425 penetrates from left parallel plate 421, through vertical lever 424 and through right parallel plate 422. This allows for vertical lever 424 to swing freely. In the present embodiment, guide tube 460 penetrates the space between parallel plates 421 and 422 and is secured to back plate 423. Semi rigid cable 462 in guide tube 460 connects to the rear of vertical lever 424 such that the upward and downward motion of vertical lever 424 moves semi rigid cable 462 in guide tube 460 upwards and downwards, which moderates volume control valve 480. Those skilled in the art, in light of the present teachings, will readily recognize a multiplicity of suitable alternative implementations of vertical control mechanisms. For example, without limitation, in one alternate embodiment, the pin may be a U-shaped rod that penetrates the vertical lever and extends back on each side to attach directly to the back plate. This embodiment does not require the vertical parallel plates. In other alternate embodiments, the vertical plates may have various different shapes such as, but not limited to, round discs, square plates, semicircular plates, etc.

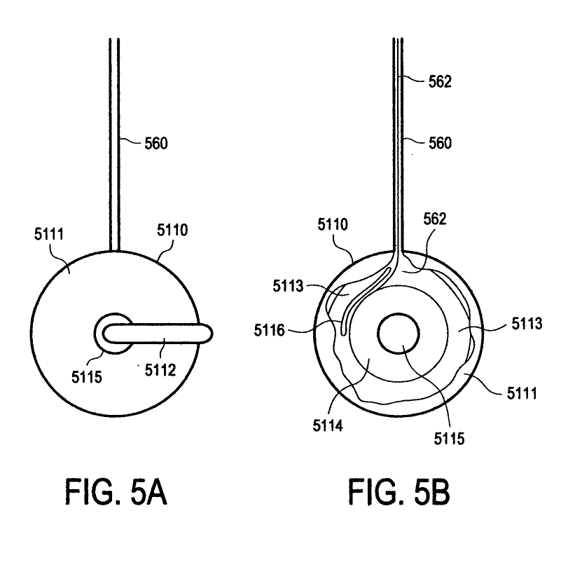

FIGS. 5A and 5B illustrate an exemplary rotating disc cable control mechanism 5110, in accordance with an embodiment of the present invention. FIG. 5A is a diagrammatic front view of rotating disc cable control mechanism 5110, and FIG. 5B is a cutaway drawing which shows the inner workings of rotating disc control mechanism 5110. In the present embodiment, rotating disc cable control mechanism 5110 is meant for use with a shower water volume control device with a semi rigid cable connected to a volume control valve, as shown by way of example in FIGS. 4A and 4B. Rotating disc control mechanism 5110 comprises a rotating disc 5114 that pushes and pulls a cable 562 through a guide tube 560 to control a volume control valve connected to the opposite end of cable 562. Referring to FIG. 5A, the outer structure of rotating disc control mechanism 5110 comprises a handle 5112 to adjust rotating disc 5114 and an outer casing 5111. Referring to FIG. 5B, rotating disc control mechanism 5110 comprises a stationary back plate 5113 that is attached to the shower wall upon which rotating disc 5114 is mounted and rotates and upon which outer casing 5111 is attached. Rotating disc 5114 is mounted to a center post 5115. Handle 5112, center post 5115 and rotating disc 5114 are all anchored securely together. Semi rigid cable 562 is attached to the side of rotating disc 5114 in alignment with guide tube 560. Immediately adjacent to rotating disc 5114 is a cable guide 5116, which maintains the tautness of cable 562 whether disc 5114 is rotating clockwise or counter clockwise. The cable guide contains the flexible cable in a small space adjacent to the rotating disc. The cable guide acts as a wall which contains the flexible cable between the rotating disc and the wall. As the rotating disc is turned, the cable must be confined to this space between the cable guide and the rotating disc. In the present embodiment, semi rigid cable 562 attaches at either an approximate 9 o'clock position or 3 o'clock position on rotating disc 5114; however, the cable may attach to the disc in various different locations in alternate embodiments. In typical use of the preset embodiment, as handle 5112 is rotated, rotating disc 5114 pulls or pushes semi rigid cable 562 through guide tube 560. Semi rigid cable 562 is connected to a linkage and then the volume control valve. Therefore, the volume control valve is opened or closed to various degrees as handle 5112 is turned.

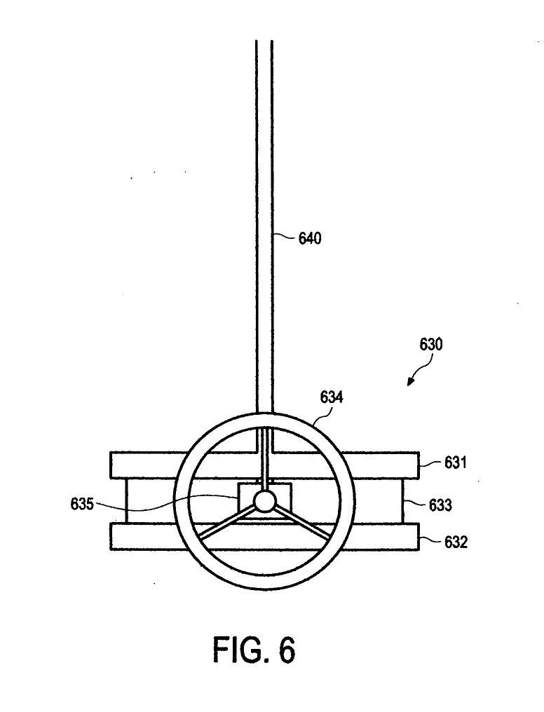

FIG. 6 is a diagrammatic front view of an exemplary dial control mechanism 630 to operate a volume control valve for a shower water volume control device, in accordance with an embodiment of the present invention. In the present embodiment, dial control mechanism 630 may be used instead of a horizontal control mechanism or a vertical control mechanism to turn a shaft 640, with or without a flexible shaft attached, or to raise and lower a semi rigid cable within shaft 640. A dial 634 is connected to a gearbox or cam 635 that transfers the rotating motion of dial 634 to move shaft 640 or a semi rigid cable within shaft 640. Those skilled in the art, in light of the present teachings, will readily recognize that there is a multiplicity of suitable alternatives for dial 634 such as, but not limited to, a knob, a fixture that matches those used in the shower installation, a crank, etc. In the present embodiment, the support structure of dial control mechanism 630 is similar to the support structures of horizontal control mechanisms 110 and 210 shown by way of example in FIGS. 1A, 1B and 2. The support structure comprises a top plate 631, a bottom plate 632 and a back plate 633. Top plate 631 and bottom plate 632 are attached to back plate 633 so that a space is left in which gearbox or cam 635 fits. In alternate embodiments the support structure of the dial control mechanism may vary. For example, without limitation, alternate embodiments may comprise only a top plate or only a bottom plate rather than both. Other alternate embodiments may not comprise plates and instead the shaft and/or the gearbox or cam may be secured to the wall using various different means such as, but not limited to, brackets, clamps, wall anchors, threaded fasteners, adhesives, etc.

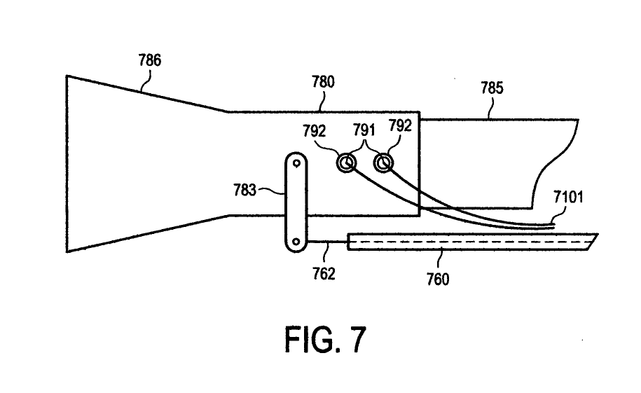

FIG. 7 is a diagrammatic side view of an exemplary showerhead 786 and volume control valve 780 integrated into one unit, in accordance with an embodiment of the present invention. In the present embodiment, the integrated unit also comprises sockets 792 for volume and temperature sensors 791. Alternate embodiments may implement an integrated showerhead and volume control unit without sensors. In the present embodiment, integrating showerhead 786, volume control valve 780 and sensor sockets 792 in one assembly provides easy installation since installation only requires attaching the entire assembly to a shower neck 785 and connecting the control means to the assembly. In the present embodiment, a semi rigid cable 762 in a guide tube 760 connected to a linkage 783 acts as the control means for volume control valve 780; however, alternate control means may be used in alternate embodiments implementing an integrated showerhead and volume control valve unit such as, but not limited to, a straight shaft with a flexible shaft as illustrated by way of example in FIGS. 2 and 3. In the present embodiment, water volume and temperature sensors 791 plug into sockets 792, which are in line with showerhead 786. Sensors 791 are at one end of data cables 101. The other ends of data cables 101 plug into a water volume and temperature gauge where the volume and temperature feedback from sensors 791 are indicated on the gauge with other information, such as, but not limited to, total water used, time, air temperature, etc. In alternate embodiments the sensors may be separate from the showerhead. In these embodiments the sensors may be located in various different locations including, but not limited to, in the volume control valve or in the shower neck.

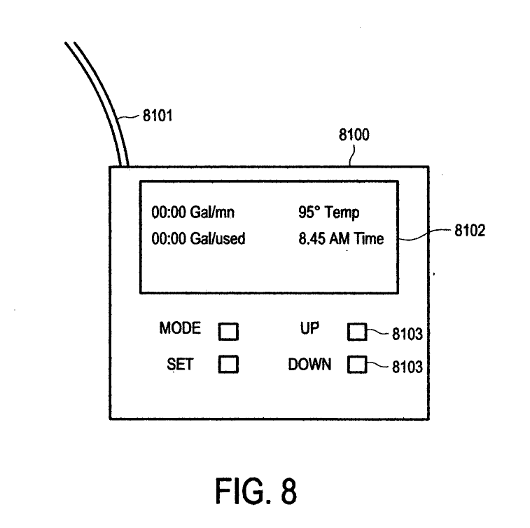

FIG. 8 illustrates an exemplary water volume and temperature gauge 8100, which may be integrated to into a shower water volume control device, in accordance with an embodiment of the present invention. In the present embodiment, gauge 8100 may be mechanical or digital and may enable a user to customize pre-set alarms. Gauge 8100 comprises a data cable 8101 that connects gauge 8100 to a sensor or sensors that fits into sockets that are in line with the showerhead. Gauge 8100 also comprises a display 8102 on which the information gathered by gauge 8100 is displayed and buttons 8103 that provide various different functions to the user such as, but not limited to, setting alarms, scrolling up or down on display 8102, selecting a mode of use, etc.

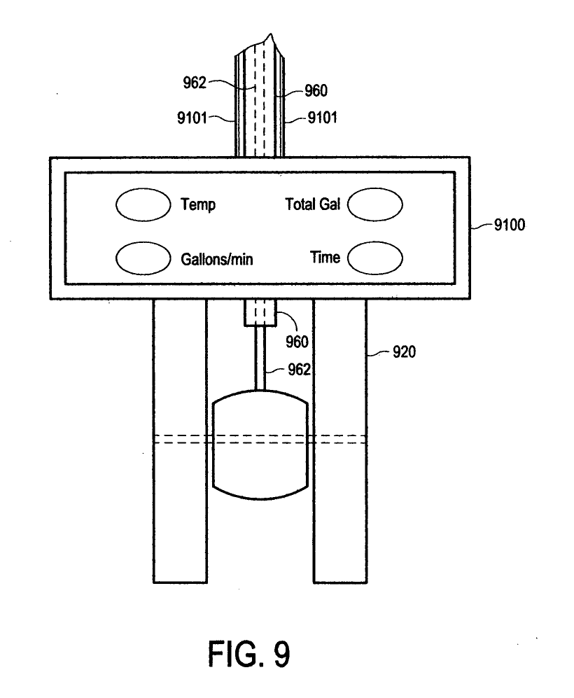

In the present embodiment, water volume and temperature gauge 8100 enables the user to view immediate and long-term feedback on water usage. For example, without limitation, gauge 8100 may indicate the length of the shower and how many gallons of water have been used. Gauge 8100 can also give the user instantaneous feedback on the current volume of water being used in gallons per minute in that moment. Gauge 8100 may also be programmed to alert the user after a pre-set length of time or a pre-set volume of water has been reached. Gauge 8100 may also remember the settings and usage of a particular individual. Those skilled in the art, in light of the present teachings, will readily recognize that a multiplicity of suitable gauges with various different functions may be used with preferred embodiments of the present invention. Furthermore, alternate embodiments may be implemented without water volume and temperature gauges. In the present embodiment, gauge 8100 is separate from the shower installation and may be placed on the shower wall using means such as, but not limited to, suction cups or hooks at a convenient location to allow easy reading of the information. However, in alternate embodiments the gauge may be integrated into the control mechanism of the shower water volume control device, as illustrated by way of example in FIG. 9.

FIG. 9 is a front view of an exemplary vertical control mechanism 920 with an integrated volume and temperature gauge 9100, in accordance with an embodiment of the present invention. In the present embodiment, gauge 9100 is located above vertical control mechanism 920; however, the gauge in alternate embodiments may be below the control mechanisms. Furthermore, a vertical control mechanism is shown in the present embodiment; however, water volume and temperature gauges may be integrated into virtually any type of control mechanism. In the present embodiment, data cables 9101 follow a guide tube 960 and connect with the top of gauge 9100. Most likely gauge 9100 is tilted upward to some extent to satisfy the viewing angle of all users. Some advantages of this placement are that it provides a less cluttered wall and a viewing position that accommodates a wide range of users including short or tall individuals. The present embodiment also offers the possibility of creating a mechanism whereby gauge 9100 may be mechanically linked to the control assembly and thus may modify the water volume in a predetermined manner. For example, without limitation, the shower may be programmed to shut off after a predetermined length of time or provide various preset volume settings to suit the preferences of the user. A power supply in gauge 9100 can provide means to mechanically adjust the volume control valve through the linkage from gauge 9100 to vertical control mechanism 920. The gauge can be preset to modify the flow of water. These preset instructions would turn on and off power to a motor in the control mechanism. A power supply in the gauge 9100 could also operate a small motor in the control mechanism. A cable from the gauge to the small motor in the control mechanism would provide the power to the motor. The motor would have mechanical means to move the control mechanism and therefore moderate the water volume. In the present embodiment the control assembly comprises a semi rigid cable 962; however, alternate control mechanisms may be connected to a water volume and temperature gauge such as, but not limited to, a rigid or flexible shaft.

In preferred embodiments of the present invention, the volume control valve must necessarily be placed before the showerhead in order to effectively control the flow of water from showerhead. In the various embodiments described in the foregoing, the volume control valve may be placed before or after the shower neck depending on the particular embodiment. Sensors may be placed before or after the volume control valve, and in some cases sensors may be integrated into the showerhead, into the volume control valve, or even into the shower neck. Preferred embodiments of the present invention may be implemented to work with any type of showerhead, although it is intended to be used with a low flow showerhead, since it is intended to be a water saving device.

Having fully described at least one embodiment of the present invention, other equivalent or alternative methods of providing a shower water volume control device according to the present invention will be apparent to those skilled in the art. The invention has been described above by way of illustration, and the specific embodiments disclosed are not intended to limit the invention to the particular forms disclosed. For example, the particular implementation of the control mechanism may vary depending upon the particular type of connection between the control mechanism and the control valve. The control mechanisms described in the foregoing were directed to mechanically connected implementations; however, similar techniques are to use a digitally operated control valve that may be connected to a digital control mechanism through wires or wirelessly. In these embodiments, the control mechanism may be integrated into the volume and temperature control gauge. Non-mechanically connected implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. An apparatus comprising:
means for controlling a flow of water to a shower head;
means for operating said controlling means; and
means for enabling an adjustment of the flow of water thereby operating said controlling means.

2. The apparatus as recited in claim 1, further comprising:
means for monitoring a volume of the flow of water;
means for monitoring a temperature of the flow of water; and
means for displaying said volume and said temperature.

3. An apparatus comprising:
a volume control valve for controlling a flow of water to a shower head, said volume control valve being configured for joining to a shower neck;
a shaft joined to said volume control valve for operating said volume control valve, said shaft being configured for extending vertically downward from said volume control valve along a shower wall; and
a control mechanism joined to a distal end of said shaft for enabling an adjustment of the flow of water, said control mechanism being configured for joining to the shower wall where a controlled motion of said control mechanism is translated by said shaft to said volume control valve thereby operating said control valve.

4. The apparatus as recited in claim 3, wherein said control mechanism further comprises a lever for imparting said controlled motion.

5. The apparatus as recited in claim 4, wherein said lever operates vertically and said controlled motion is linear.

6. The apparatus as recited in claim 3, further comprising:
a water volume sensor for monitoring a volume of the flow of water;
a temperature sensor for monitoring a temperature of the flow of water; and
a gauge assembly in communication with said water volume sensor and said temperature sensor for displaying said volume and said temperature.

7. The apparatus as recited in claim 3, wherein at least part of said shaft is flexible.

8. The apparatus as recited in claim 3, further comprising at least one support for supporting said shaft.

9. The apparatus as recited in claim 3, wherein said shaft is hollow and comprises a cable for translating said controlled motion.

10. The apparatus as recited in claim 3, wherein said volume control valve is configured for joining between the shower neck and the shower head.

11. The apparatus as recited in claim 3, wherein said volume control valve further comprises a shower head.

12. The apparatus as recited in claim 6, wherein said gauge assembly comprises electronic displays.

13. The apparatus as recited in claim 12, wherein said gauge assembly further displays time and time related data.

14. The apparatus as recited in claim 13, wherein said gauge assembly is programmable.

15. The apparatus as recited in claim 14, wherein said gauge assembly is joined to said control mechanism.

16. The apparatus as recited in claim 15, wherein said gauge assembly is configurable for imparting said controlled motion.

17. An apparatus comprising:
a volume control valve for controlling a flow of water to a shower head, said volume control valve being configured for joining between a shower neck and the shower head;
a guide tube comprising a cable joined to said volume control valve for operating said volume control valve by motion of said cable, said guide tube being configured for extending vertically downward from said volume control valve along a shower wall; and
a control mechanism comprising a lever and joined to a distal end of said guide tube for enabling an adjustment of the flow of water, said control mechanism being configured to join to the shower wall where a controlled motion of said lever is translated by said cable as a linear motion to said volume control valve thereby operating said control valve.

18. The apparatus as recited in claim 17, further comprising:
a water volume sensor for monitoring a volume of the flow of water;
a temperature sensor for monitoring a temperature of the flow of water; and
a programmable gauge assembly in communication with said water volume sensor and said temperature sensor for displaying said volume, said temperature, time and time related data.

19. The apparatus as recited in claim 18, wherein said gauge assembly is joined to said control mechanism.

20. The apparatus as recited in claim 19, wherein said gauge assembly is configurable for imparting said controlled motion.
